(19) United States
(12) Patent Application Publication
(10) Pub. No.: US 2019/0064463 A1
(43) Pub. Date: Feb. 28, 2019

(54) IN-LINE OUTDOOR FAÇADE OPTICAL FIBER DISTRIBUTION CLOSURE

(71) Applicant: OFS Fitel, LLC, Norcross, GA (US)

(72) Inventors: James C Bandy, Duluth, GA (US); Denis E Burek, Cumming, GA (US); Xavier Chiron, Atlanta, GA (US); Lynda Price, Oakwood, GA (US); Willard C White, Suwanee, GA (US)

(73) Assignee: OFS Fitel, LLC, Norcross, GA (US)

(21) Appl. No.: 16/139,786

(22) Filed: Sep. 24, 2018

Related U.S. Application Data
(63) Continuation-in-part of application No. 15/935,222, filed on Mar. 26, 2018.
(60) Provisional application No. 62/643,886, filed on Mar. 16, 2018.
(60) Provisional application No. 62/536,627, filed on Jul. 25, 2017.

(51) Int. Cl. G02B 6/44; G02B 6/38

(52) U.S. Cl. CPC G02B 6/4452; G02B 6/4455; G02B 6/4441; G02B 6/3897

(57) ABSTRACT

A fiber distribution module includes a base having a wall with a first flange, a cover having a wall with a second flange, and a sealing element. Latches clamp the cover to the base, and, with the sealing element, act to produce a weather tight seal. Each latch has a lever with a lower hook portion, and a lever arm. The latch also has a catch of U-shaped cross section, a lower arm, and an upper arm. Each latch clamps the module cover to the base weather tight when (i) a distal end of the lower arm of the catch engages the first flange on the base wall, and (ii) the lever arm is urged to closed a position where the lower hook portion of the lever applies a force on the second flange on the cover wall which compresses the sealing element to obtain the weather tight seal.

### CROSS REFERENCE TO RELATED APPLICATIONS

This application claims priority under 35 U.S.C. § 119(e) of U.S. Provisional Patent Application No. 62/643,886 filed Mar. 16, 2018, titled Facade Outside Plant Inline Closure, the entire contents of which are incorporated by reference.

This application is also a continuation-in-part of our copending U.S. patent application Ser. No. 15/935,222 filed Mar. 26, 2018, titled In-Line Outdoor Optical Fiber Distribution Module, which claims priority under § 119(e) of U.S. Provisional Patent Application No. 62/536,627 filed Jul. 25, 2017.

### BACKGROUND OF THE INVENTION

### Field of the Invention

The present invention relates to closures or modules for storing optical fibers and cables, and particularly to modules that store connections between fibers of a network distribution cable, and fibers associated with living units or premises in a multiple dwelling unit (MDU) building.

### Discussion of the Known Art

Multi-fiber optical network distribution cables are commonly installed through hallways in a MDU building to enable occupants of premises along the hallways to access a fiber optic network. Each fiber of a network distribution cable is usually designated for a premises located next to or near the hallway through which the cable is installed.

In a typical installation, a point-of-entry (POE) fiber access module is mounted on the hallway wall close to an entry point of each premises, and a network distribution cable routed along the wall is arranged to pass inside the module. A short length of the cable jacket is opened, and a fiber which is designated for the premises is identified and removed from the cable. The designated fiber is connected to a drop fiber that is routed to pass from inside the module, through the hallway wall, and into the premises.

The connections between the designated cable fibers and the premises drop fibers are made, e.g., by terminating a designated cable fiber and its associated drop fiber each with an optical connector, and coupling the connectors to one another through an adapter mounted inside the module. See U.S. Pat. No. 9,632,267 (Apr. 25, 2017) and U.S. Pub. No. 2017/0285272 (Oct. 5, 2017), both of which are assigned to the present applicant and incorporated by reference. Connections between the designated fibers of the distribution cable and the associated drop fibers can also be made using known fusion splicing techniques, and storing the fused ends of the fibers in a splice tray inside the module.

Occasions arise, however, in which hallways or other pathways allotted for network distribution cables inside a MDU building can no longer accommodate an additional cable. For example, new premises may become available along a given hallway, but all of the fibers of an existing hallway distribution cable have been designated for existing premises. Also, the building owner may not permit another distribution cable to be installed through the hallway, or allow the existing cable to be replaced by a new one with a higher fiber count.

U.S. Pat. No. RE 42,258 (Mar. 29, 2011) relates to outside plant fiber distribution apparatus including a frame, and a number of fiber optic modules including connection, storage, and blank modules that are selected to fill the frame with desired functions. U.S. Pat. No. 6,792,191 (Sep. 14, 2004) discloses an outdoor cabinet for interconnecting an optical fiber of a feeder cable with at least two fibers of a distribution cable at a local network convergence point. Other cabinets or enclosures for storing and interconnecting fiber optic distribution cables with other cables or fibers are disclosed in U.S. Pat. No. 8,315,057 (Nov. 20, 2012) and U.S. Pub. No. 2017/0052339 (Feb. 23, 2017). The mentioned patents and published patent application are also incorporated by reference.

Notwithstanding the known art, there is a need for an outdoor, weather-proof fiber distribution module that can be installed along a network distribution cable located outside a MDU building, wherein (a) one or more of the modules can be installed in-line along the length of the cable, (b) the fibers of the distribution cable can be connected to drop fibers that pass from inside the module to premises in the building, and (c) the distribution cable, the drop fibers, and the connections between them are sealed from the outdoor environment when the module is closed.

Moreover, if the building owner does not allow the module and the distribution cable to be physically attached to an outside wall or façade of the building, the module must be able to be supported only by the distribution cable if the cable is routed aerially near the building, without impairing the integrity of the cable or any connections stored inside the module under such conditions.

In addition, there is a need for a fiber distribution module constructed so that the module can be kept open to allow an installer to use both hands to perform all required fiber splices and connections, and then easily closed and sealed weather tight by the installer without special tools while standing on a ladder outdoors.

### SUMMARY OF THE INVENTION

According to the invention, an optical fiber distribution closure or module includes a base having a wall with a first flange formed along a closing edge of the base wall, and cable ports formed in the wall for passing a network distribution cable through the module. Fiber ports are also formed in the base wall for passing drop fibers from inside the module where the fibers connect with designated fibers of the distribution cable, to premises inside a multi-dwelling unit (MDU) building for which the cable fibers are designated. The module also includes a cover having a wall with a second flange along a closing edge of the cover wall, and an associated sealing element.

Latches are constructed and arranged for clamping the module cover to the base to close the module, and to produce a weather tight seal in cooperation with the sealing element. Each latch includes a lever having a lower hook portion, and a lever arm. The latch also has a catch with a generally U-shaped cross section, a lower arm, and an upper arm.

The lower arm of the catch is formed to engage the first flange on the base wall. The upper arm of the catch is formed to seat within the lower hook portion of the lever. The lever and the catch are configured so that when the module cover is lowered on the base and (i) the distal end of the lower arm of the catch engages the first flange on the base wall, and (ii) the lever arm is urged to a closed position, a bottom surface on the lower hook portion of the lever applies a compressive force on the second flange on the cover wall and the sealing element to produce the weather tight seal.

For a better understanding of the invention, reference is made to the following description taken in conjunction with the accompanying drawing and the appended claims.

### BRIEF DESCRIPTION OF THE DRAWING FIGURES

In the drawing:

FIG. 1 is an exploded assembly view of a first embodiment of an outdoor optical fiber distribution closure or module according to the invention;

FIG. 2 is an exploded assembly view of a second embodiment of an outdoor optical fiber distribution closure or module according to the invention;

FIG. 3 is an enlarged isometric view of a base of the inventive distribution modules shown in FIGS. 1 and 2;

FIG. 4 is an enlarged isometric view of a cover of the inventive modules in FIGS. 1 and 2;

FIG. 5 is an enlarged inside view of the cover of the inventive modules in FIGS. 1 and 2;

FIG. 6A is an isometric view of a blank grommet seal for insertion in an open cable or fiber port of the modules;

FIG. 6B is an isometric view of a grommet seal for insertion in a module port through which a cable or fiber is passed;

FIG. 7 is an enlarged view of a tray in the first embodiment of the module in FIG. 1;

FIG. 8 is an enlarged view of an adapter holder in the first embodiment of the module in FIG. 1;

FIG. 9 is an enlarged view of a slack storage tray in the second embodiment of the module in FIG. 2;

FIG. 10 is an enlarged view of a splice holder in the second embodiment of the module in FIG. 2;

FIG. 11 is an isometric view of a third embodiment of an outdoor optical fiber distribution closure or module in a closed state according to the invention;

FIG. 12 is an isometric view of the module in FIG. 11 with a module cover swung to an open position;

FIG. 13 an exploded assembly view of a base of the module in FIGS. 11 and 12;

FIG. 14 is an isometric view of the module cover showing a series of hinge elements formed on the cover;

FIG. 15 is a side elevation view of a hinge element on the module cover in FIG. 14;

FIG. 16 is an isometric view of one of a number of two-part latches used to close the module cover over the base, according to the invention;

FIG. 17 is a side elevation view of the latch in FIG. 16;

FIG. 18 is an isometric view of the base of the module when assembled as in FIG. 13;

FIG. 19 is an enlarged view of a portion of the assembled module base in FIG. 18;

FIG. 20 is an isometric view of the interior of a splice tray according to the invention;

FIG. 21 is a view of one of two fiber ports on the splice tray in FIG. 20 with a cover closed over the port, according to the invention;

FIG. 22 is a view of the second fiber port on the splice tray with the cover in an open position;

FIG. 23 is an isometric view of two of the splice trays in FIG. 20 pivoted to one another according to the invention;

FIG. 24 is an enlarged view of pivot connections on the trays in FIG. 23;

FIG. 25 is a side elevation view of the pivoted trays in FIGS. 23 and 24;

FIG. 26 is a partial view of the sides of the pivoted trays when latched flush with one another, according to the invention;

FIG. 27 is another partial view of the sides of the latched trays in FIG. 26, including a portion of a tray cover;

FIG. 28 is an isometric view of the inventive fiber distribution module when open, including connector adapters mounted on the base and three splice trays pivoted to the base; and

FIG. 29 is an isometric view of the module in FIG. 28, showing the splice trays swung atop and latched to the base for storage.

### DETAILED DESCRIPTION OF THE INVENTION

As used herein, the terms premises, living unit, and user, are used interchangeably to refer to an apartment, office, conference room, or any other defined space within a MDU building designated by the building owner or management to allow access by persons occupying the space to a fiber optic network by way of a network distribution cable that is routed nearby.

The present invention offers a solution when no more fibers of an existing fiber optic network distribution cable inside a MDU building are available to service new premises in the building. In addition to routing or suspending a new network distribution cable outside the building, one or more outdoor optical fiber distribution modules according to the invention are installed in-line along the cable. Drop fibers associated with the premises are connected to designated fibers of the distribution cable inside each module. The drop fibers pass from inside each module, and through an outside wall of the building to service the associated premises. The module is relatively inexpensive, weather resistant, and lightweight. It can be easily mounted on an outside wall of the building, or supported only by the distribution cable if the cable is hung aerially outdoors near the outside wall.

Network distribution cables capable of deployment outdoors include, inter alia, 12-fiber cables available from OFS Fitel, LLC under the registered trademarks Accudry and M-Pack, and 24-fiber M-Pack cables. The cables can be clipped to an outside building wall similar to a coaxial cable TV run, using just screws and plastic cable retainers. For example, at periodic locations along the cable, the cable jacket can be slit open a first time, approximately 28 inches from a deployment point where a module according to the invention will be installed along the cable. A number of cable fibers designated for the premises inside the building can then be identified and cut through the open slit by a conventional cutting tool.

At each deployment point along the distribution cable, the cable jacket is slit open a second time. Lengths of those fibers that were cut through the first slit are withdrawn through the second slit and terminated in connectors, and the connectors are mated to corresponding adapters inside the module. Drop fibers associated with the premises in the building are also connectorized, mated to corresponding fibers of the distribution able via the adapters, and routed from inside the module to the premises through pathways in an outside building wall or façade. Instead of using connectors and adapters, and as noted earlier, the ends of the drop fibers can be fusion spliced on site to ends of the corresponding distribution cable fibers, and the fused ends of the spliced fibers sleeved and stored inside the module.

If the module will be mounted directly on an outside building wall, a hole can be drilled through the wall to open into the premises, or into a duct or channel leading to the premises inside the building. The hole is preferably located away from the module footprint to facilitate routing and bending of the drop fibers. The drop fibers can pass from the module, through the hole, and routed inside the building to the associated premises. Jacketed drop fibers with outer diameters of 3.0 mm, 3.8 mm, and 4.8 mm, and suitable for outdoor deployment include 12 and 24 fiber M-Pack EZ Bend, 12 fiber Allwave Accudry, and single fiber interconnect EZ Bend, all of which are available from OFS Fitel, LLC.

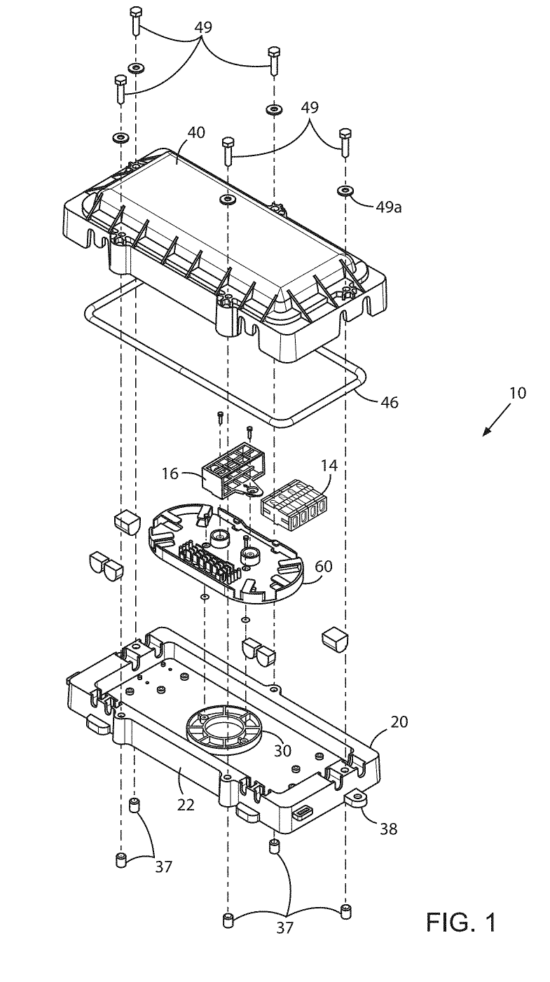

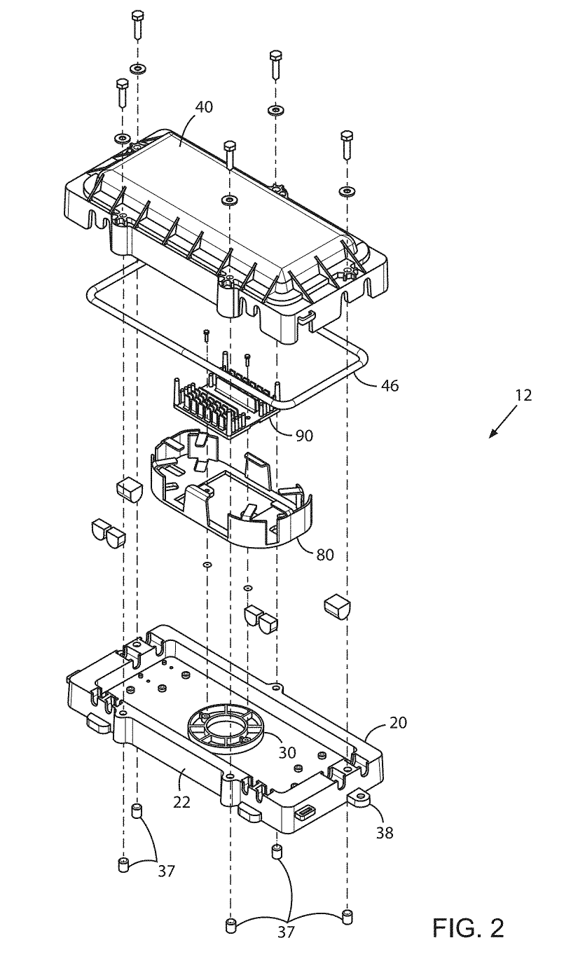

FIG. 1 is an assembly view of a first embodiment of an outdoor optical fiber distribution module 10 according to the invention, and FIG. 2 is an assembly view of a second embodiment of an outdoor optical fiber distribution module 12 according to the invention. In the disclosed embodiments, module 10 is constructed and arranged to retain up to six fusion splices within, e.g., 45 mm long splice sleeves, and to mount up to four adapters 14 in an adapter holder 16 for coupling connectors at the ends of the drop fibers and cable fibers to one another. The adapters 14 may be formed to accept, for example, simplex SC APC or duplex LC APC type connectors. Module 12 is constructed and arranged to retain up to 24 fusion splices within 45 mm long splice sleeves.

As described below, each of the modules 10, 12 has two cable ports for passing a distribution cable through an interior region of the module where certain designated fibers of the cable are managed, and six fiber ports for passing jacketed drop fibers from the module for routing to corresponding premises inside a MDU building. In addition to meeting certain standards noted below, the modules 10, 12 should comply with industry standards IP56 and IK06 for ingress and impact protection when the modules are closed and installed outdoors.

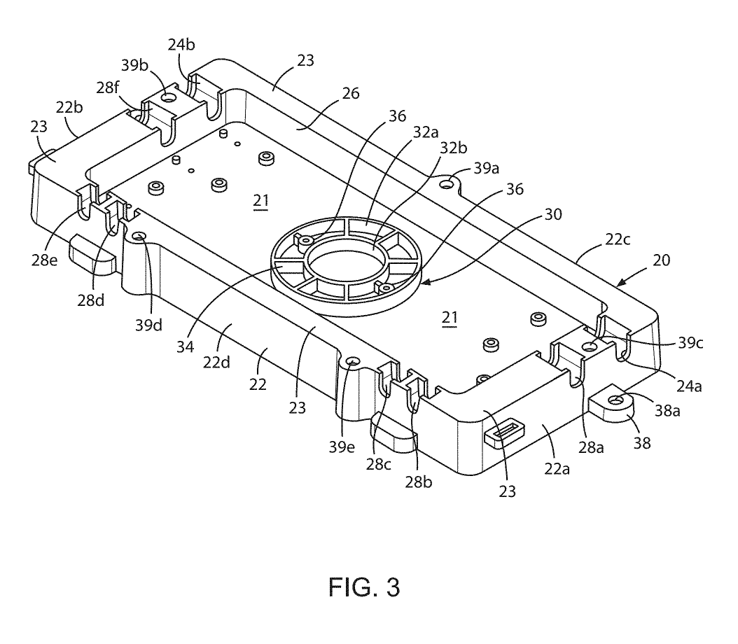

Each module 10, 12 has a generally rectangular base 20, an enlarged view of which is shown in FIG. 3. The base 20 measures, for example, approximately 9.061 inches in length and approximately 3.975 inches in width. The base also has a surrounding wall 22 that extends vertically upward approximately 0.825 inch in overall height as viewed in the drawing. Base 20 can be formed of a UV resistant and RoHS compliant material such as, e.g., glass fiber reinforced polypropylene.

The base wall 22 has a pair of distribution cable ports 24a, 24b formed in first and second short sides 22a, 22b of the wall 22, and near a first long side 22c of the wall as shown in FIG. 3. The ports 24a, 24b enable an outdoor distribution cable to pass straight through an interior region 26 of each module 10, 12. Ports 24a, 24b are in the form of generally U-shaped notches that extend downward from the top of the wall 22, wherein the bottom of each port rounded. The side walls of each cable port may be slightly inclined toward one another from the top of the base wall, so as to form a tight weatherproof seal with the jacket of a distribution cable when the cable is urged toward the bottom of the port.

Base wall 22 also has six fiber ports 28a-f, two of which (28a and 28f in FIG. 3) are also formed in the first and second short sides 22a, 22b of the wall, and near cable ports 24a, 24b as shown in FIG. 3. Two fiber ports 28b, 28c are formed next to one another in a second long side 22d of the base wall 22, and close to the first short side 22a of the wall. The other two fiber ports 28d, 28e are also formed next to one another in the second long side 22d of the base wall 22, and close the second short side 22b of the wall. Like the distribution cable ports 24a, 24b, the fiber ports 28a-e are in the form of generally U-shaped notches that extend downward from the top of the base wall 22, and the bottom of each port is rounded. The side walls of each fiber port are also slightly inclined toward one another from the top of the base wall, so as to form a tight weatherproof seal with the jacket of a drop fiber when the fiber is urged toward the bottom of the port.

Accordingly, the fiber ports 28a-f allow corresponding drop fibers to pass from the interior region 26 of the module base 20 where the drop fibers are connected to designated fibers of the distribution cable, to those premises inside a MDU building for which the fibers are designated. It will be understood, however, that fewer or more than six fiber ports may be formed in the base wall 22 depending on, inter alia, a greatest number of drop fibers that are expected to be handled by any one of the inventive modules 10, 12.

A circular boss 30 is formed at the center of the interior region 26 of the module base 20. See FIGS. 1, 2, and 3. In the disclosed embodiments, the boss 30 is defined by two concentric circular rings 32a, 32b, and wall segments 34 that extend radially between the rings 32a, 32b every 45 degrees. The rings 32a, 32b and the wall segments 34 project, for example, approximately 0.220 inch above the flat interior surface 21 of the base 20. Two of the wall segments 34 that are 180 degrees apart and are aligned parallel to the long axis of the base 20, are formed with rounded bosses 36 (see FIG. 3) that have holes for engaging mounting screws associated with certain interior components, described below. The boss 30 including the rings 32a, 32b and the wall segments 34 together define a secure mounting platform for the components, and act as a bend limiter when routing fibers.

Two mounting lugs 38, one of which is shown in FIGS. 1, 2, and 3, are disposed at the bottom of the module base 20. The lugs 38 project from opposite sides of the base, and each lug has a hole 38a for passing a screw or other fastener to mount the base 20 on a flat surface outdoors, e.g., an outside building wall or façade. If the building owner will not allow the modules 10, 12 to be physically attached to a wall or other exterior structure, then one or more modules can be supported solely by an outdoor distribution cable on which they are installed.

In addition, five openings 39a-e, shown in FIGS. 1 to 3, are formed vertically over the entire height of the wall 22 of the module base 20. One opening 39a is formed through a boss that protrudes from the long side 22c of the wall 22, midway over the length of the side 22c. Openings 39b, 39c are formed directly through the base wall 22 at locations between ports 24a, 28a on short side 22a of the wall, and between ports 24b, 28f on short side 22b of the base wall. Openings 39d, 39e are formed through corresponding bosses that protrude from the long side 22d of the base wall 22 near fiber ports 28b, 28c at one end of the long side 22d, and near fiber ports 28d, 28e at the other end of the side 22d. As shown in FIGS. 1 and 2, threaded sleeves 37 are press fit or otherwise retained inside the vertical openings 39a-e formed in the wall 22 of the module base 20.

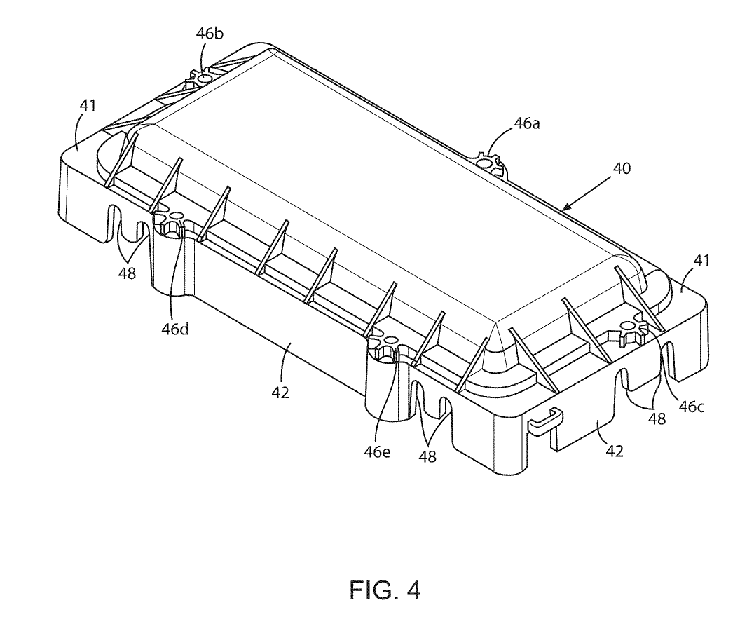

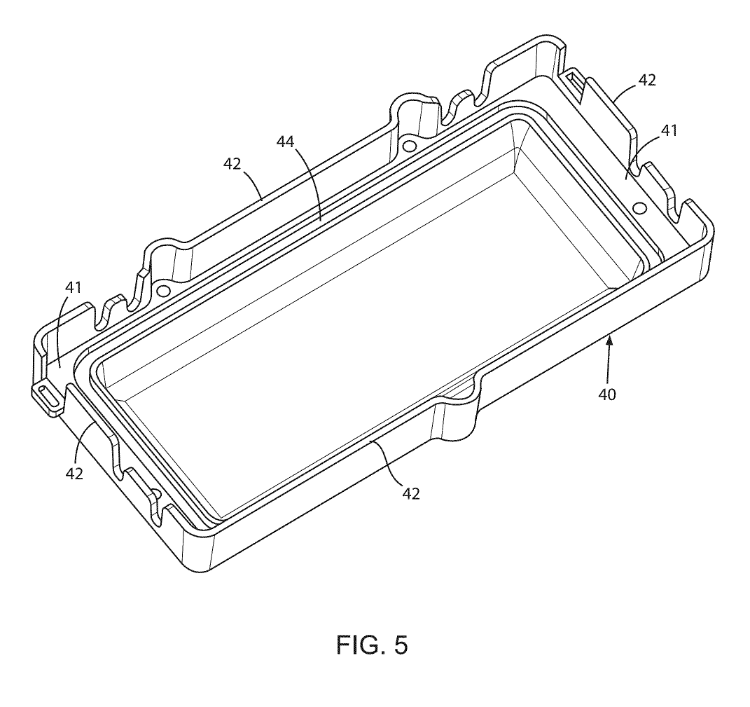

Each module 10, 12 also has a cover 40, top views of which are shown in FIGS. 1, 2, and 4. FIG. 5 is a bottom view of the module cover 40. The cover 40 measures, for example, approximately 9.277 inches in overall length and approximately 4.19 inches in overall width. The cover 40 has a surrounding flat lip 41, and a wall 42 that extends approximately 1.725 inches downward from the perimeter of the lip 41 as seen in FIG. 4. Like the module base 20, the cover 40 can be formed of a UV resistant and RoHS compliant material such as glass fiber reinforced polypropylene, or equivalent.

Five openings 46a-e are formed vertically over the entire height of the wall 42 of the module cover 40. One opening 46a is formed through a boss that protrudes from a first long side of the cover wall 42 and midway over the length of the wall 42. Openings 46b, 46c are each formed through the flat lip 41 of the cover 40 between a first pair of notches 48 in the cover wall 42 that coincide with ports 24a, 28a in the wall 22 of the module base 20 when the cover 40 is fastened to the base to close the module, and between a second pair of notches in the cover wall 42 that coincide with ports 24b, 28f in the wall 22 of the module base when the module is closed. Openings 46d, 46e are formed through bosses that protrude from the second long side of the cover wall 42, near a third pair of notches 48 that coincide with fiber ports 28b, 28c in the wall 22 of the module base when the module is closed and near a fourth pair of notches 48 that coincide with fiber ports 28d, 28e in the wall 22 of the module base 20 when the module is closed.

Once all fiber connections are made and managed over the interior surface 21 of the module base 20, the modules 10, 12 are closed by placing the cover 40 over the base 20 so that the wall 42 of the cover surrounds the wall 22 of the base, and the openings 46a to 46e in the cover wall 42 are in alignment with the openings 39a to 39e in the base wall 22. Threaded bolts 49 are inserted with associated flat washers 49a into the aligned openings, so that bolts 49 engage corresponding ones of the threaded sleeves 37 captured in the openings 39a-e in the base wall. The bolts 49 are tightened in a certain order and to a sufficient degree so that the interface between the cover 40 and the base 20 is properly sealed, as explained further below.

A channel 44 is formed to a depth of approximately 0.160 inch in the interior surface of the cover lip 41, and parallel to the cover wall 42 as shown in FIG. 5. The bottom of the channel 44 defines a continuous and smooth sealing surface along which an oil resistant, O-ring sealing element 46 (see FIGS. 1 and 2) having an outer diameter of, e.g., 0.21 inch is disposed. A certain portion of the sealing element 46 is allowed to protrude above the channel 44. When the module cover 40 is fastened to the base 20 as explained above, the protruding sealing element 46 is urged against the top surface 23 of the base wall 22, and the entire sealing element is contained in a compressed state inside the channel 44. The interface between the interior surface of the cover lip 41 and the top surface 23 of the base wall 22 is thus sealed from the outdoor environment when the modules 10, 12 are closed.

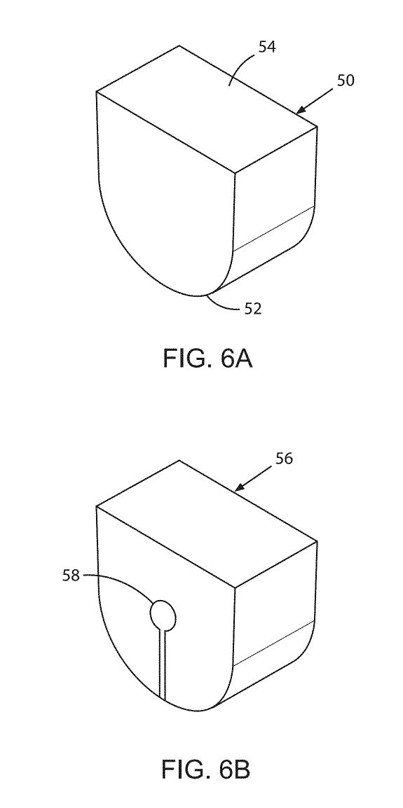

Each one of the fiber ports 28a to 28f also has an associated first seal or grommet 50 shown in FIG. 6A. Before the module cover 40 is fastened to the base 20, the seal 50 is dimensioned and formed to be urged into each unused fiber port (if any) from above, and to close the port fully with a tight fit. The seal has a lower rounded portion 52 that conforms to the rounded bottoms of the fiber ports. An upper flat surface 54 of the seal 50 rises slightly above the top surface 23 of the base wall 22 when the seal 50 is inserted in an unused port. The seal 50 is therefore compressed against a length of the sealing element 46 in the module cover 40 when the cover is fastened to the base 20, and the seal 50 cooperates with the sealing element 46 to seal the unused port from the outdoor environment. Each seal 50 can be formed of silicone that is UV and chemical resistant, and RoHS compliant. To facilitate installation of seal 50 in an unused fiber port, a thin film of silicone sealant can be applied on the lower rounded portion 52 of the seal.

The cable ports 24a, 24b, and each of the fiber ports 28a-f, also have associated second seals or grommets 56 shown in FIG. 6B. The second grommets 56 are similar in outside form to the first grommets 50. The grommets 56 also have openings 58 for passing the distribution cable and the drop fibers so that the grommets 56 surround them in sealing relation when the grommets are urged with the passing cable or fibers into the corresponding ports.

To facilitate passing the cable or fibers through the second grommets 56, the grommets are split vertically through the center line of their lower rounded portions. The upper flat portions of the grommets are not split. Like the first grommets 50, the top surfaces of the grommets 56 must be continuous, smooth, and flat for the cover sealing element 46 to seal against. The force of the module cover 40 against the base 20 when either module 10, 12 is closed, forces the slits in the second grommets 56 to close tightly.

The holes in the second grommets 56 are sized approximately 0.010 inch less than the nominal O.D. of the passing cable or fiber. Because of this, a slight bulge in the grommet will be produced when the cable or fiber is passed through the split to occupy the hole in the grommet. When the module 10 or 12 is closed and the sealing element 46 in the module cover 20 is forced down against the top of the second grommets 56, the bulge is compressed and the associated port is sealed water-tight from the outdoor environment.

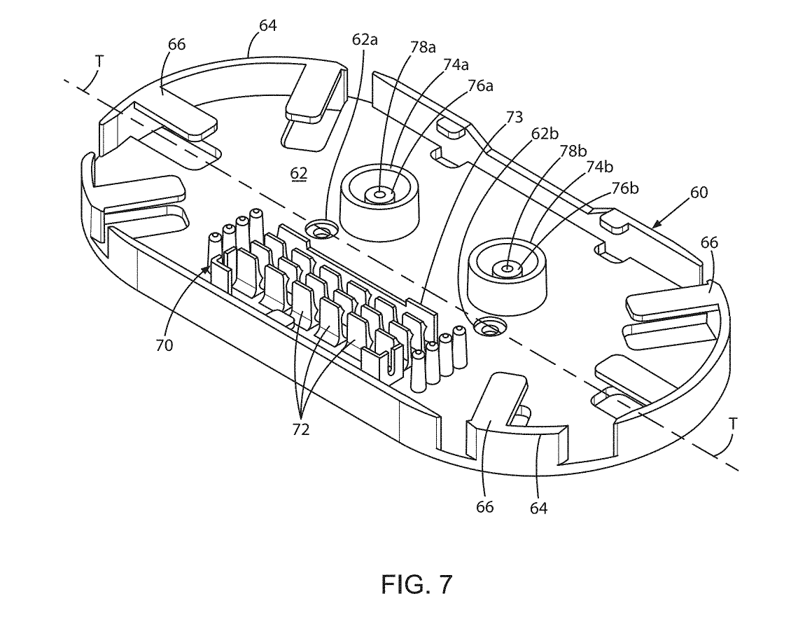

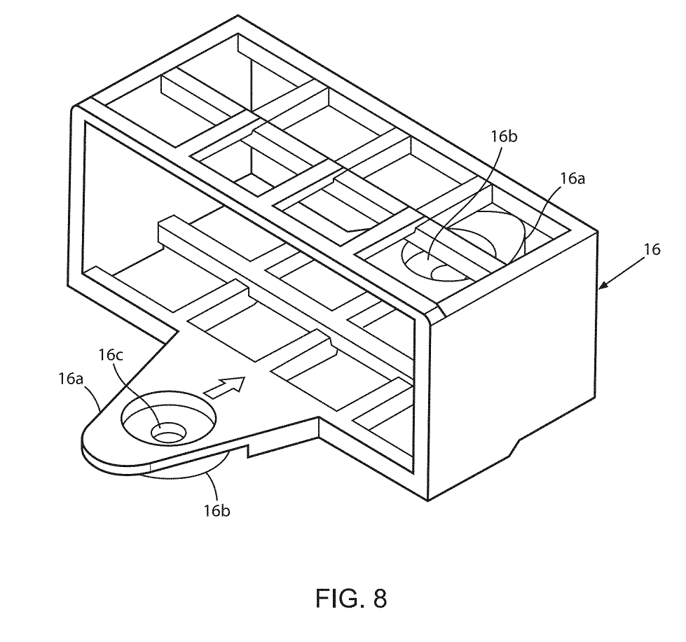

As disclosed earlier and shown in FIG. 1, module 10 is constructed to retain up to six fusion splices within 45 mm splice sleeves, and to mount up to four connector adapters 14 in an adapter holder 16. FIG. 7 is an enlarged view of a tray 60 in FIG. 1, wherein the tray 60 has a stadium shaped perimeter, and a floor 62 that is arranged to mount flush atop the circular boss 30 on the inside surface 21 of the module base 20. FIG. 8 is an enlarged view of the adapter holder 16 in FIG. 1. The tray 60 and the holder 16 can be made of RoHS compliant polypropylene or an equivalent material.

Two holes 62a, 62b that coincide with a long axis T of the tray 60 are formed in the floor 62 of the tray. The holes 62a, 62b are spaced apart by the same distance (e.g., approx. 1.639 in.) as are the holes in the bosses 36 on the wall segments 34 of the boss 30. The tray 60 is mounted on the boss 30 by inserting screws through the holes 62a, 62b, and threading them into the holes in the bosses 36.

Tray 60 has a surrounding wall 64 that extends upward from the perimeter of the tray floor 62 to a height of approximately 0.350 inch, and a number of retaining fingers or tabs 66 project radially inward from a top edge of the wall 64 to help contain the cable and drop fibers that are connected to one another between the tray floor 62 and the top of the surrounding wall 64.

A fusion splice holder section 70 is provided in a central region of the tray floor 62, at one side of the long axis T. In the disclosed embodiment, the holder section 70 includes three parallel rows of retaining fingers or tabs 72 and a parallel catch wall 73, all of which project upward from the floor 62 to a height of approximately 0.270 inch. Each row of tabs 72 and the wall 73 are about 1.550 inches long, and are spaced approximately 0.106 inch apart from one another. Accordingly, splice holder section 70 is capable of retaining up to a total of six fusion splices, wherein each splice is protected inside a 45 mm long splice sleeve, and up to two splice sleeves can be inserted between and gripped by any two adjacent rows of the retaining tabs 72 and the catch wall 73.

The tray 60 also has a first pair of annular bosses 74a, 74b that project from the tray floor 72 to a height of approximately 0.270 inch. The bosses 74a, 74b are offset a certain distance from the side of the long axis T opposite the splice holder section 70. A second pair of annular bosses 76a, 76b, each of smaller diameter and disposed concentrically inside the first pair, project to a lesser height of approx. 0.205 inch above the floor 72. Each boss of the second pair 76a, 76b has a corresponding hole 78a, 78b formed axially from the top, for mounting the adapter holder 16.

As shown in detail in FIG. 8, the adapter holder 16 has a generally rectangular, box-like shape which is formed and dimensioned to receive and retain four adapters 14 side-by-side as shown in FIG. 1. A pair of mounting feet 16a project from opposite sides of the holder 16. Each foot 16a has a cylindrical boss 16b that projects downward from the foot as viewed in FIG. 8, and each boss 16b has an axial mounting hole 16c. The distance between the two mounting holes 16c in the feet 16a of the adapter holder 16 is set equal to the distance between the mounting holes 78a, 78b in the second pair of bosses 76a, 76b on the tray 60. The adapter holder 16 is mounted on the tray 60 by centering the bosses 16b on the feet of the holder within the first pair of annular bosses 74a, 74b on the tray 60, inserting screws through the mounting holes 16c in the bosses, and threading the screws into the holes 78a, 78b in the bosses 76a, 76b on the tray 60.

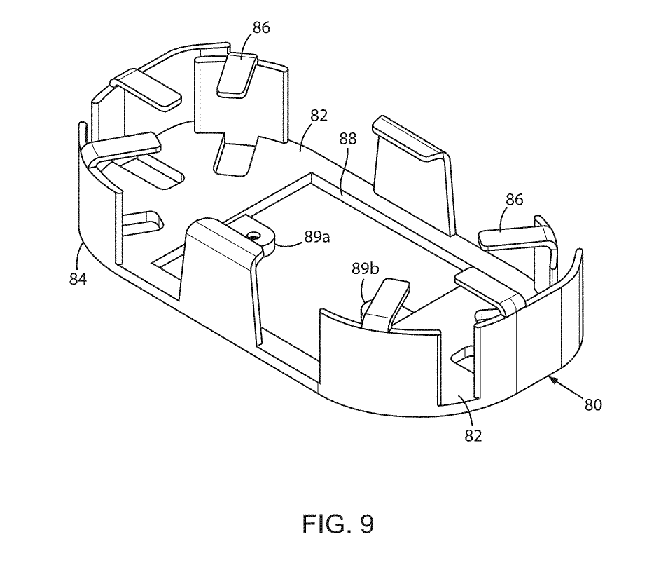

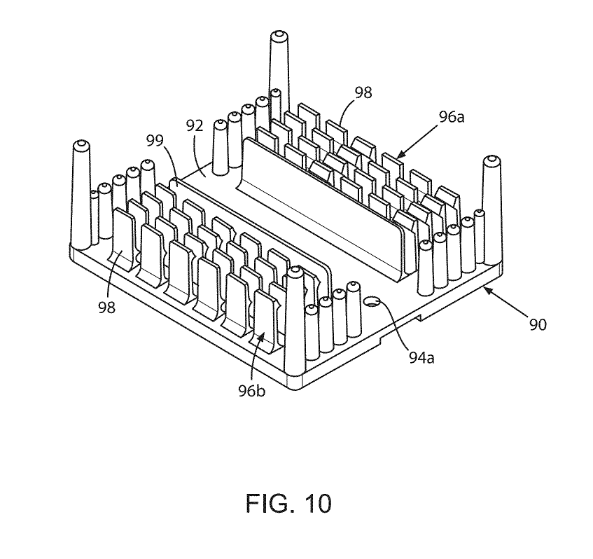

As described earlier and shown in FIG. 2, module 12 is constructed to retain up to 24 fusion splices within 45 mm splice sleeves. FIG. 9 is an enlarged view of a tray 80 in FIG. 2, wherein the tray 80 has a stadium shaped perimeter, and a floor 82 that is configured to mount flush atop the circular boss 30 on the base 20 of the module 12. FIG. 10 is an enlarged view of a fusion splice holder or tray 90 in FIG. 2.

Tray 80 has a surrounding wall 84 that extends upward from the perimeter of the tray floor 82 to a height of approximately 1.010 inch, and a number of retaining fingers or tabs 86 that project radially inward from a top edge of the wall 84 to help contain cable and drop fibers that are spliced to one another between the tray floor 82 and the top of the surrounding wall 84. A rectangular opening 88 is formed through a central region of the tray floor 82, and a pair of mounting lugs 89a, 89b extend from opposite sides of the opening 88. When the tray 80 is placed atop the boss 30 on the module base 20, the lugs 89a, 89b have mountings holes located to coincide with the holes in the two bosses 36 inside the boss 30 on the module base 20.

Splice holder 90 has a rectangular base 92, with a pair of mounting holes 94a one of which is shown in the drawing. The holes 94a are located to coincide with the holes through the mounting lugs 89a, 89b on the tray 90. When the splice holder 90 is disposed within the rectangular opening 88 in the tray, the holder 90 and the tray 80 can be mounted together atop the boss 30 on the module base 20 by passing screws through the holes 94a in the holder base 92, through the openings in the mounting lugs 89a, 89b on the tray, and threading the screws into the two bosses 36 on the module base 20.

Two fusion splice holder sections 96a, 96b are formed atop the base 92 of the holder 90, on opposite sides of the openings 94a. Each section 96a, 96b includes four parallel rows of retaining fingers or tabs 98 and a solid catch wall 99, all of which project upward from the base 92 to a height of approximately 0.412 inch. Each row of tabs 98 and the wall 99 are about 1.550 inches long, and are spaced approximately 0.106 inch apart from one another. Accordingly, the splice holder sections 96a, 96b together are capable of retaining a total of 24 fusion splices, wherein each splice is protected inside a 45 mm long splice sleeve, and up to three splice sleeves can be inserted between and gripped by any two adjacent rows of the retaining tabs 96a, 96b and the catch wall 99.

FIGS. 11 to 27 show a third embodiment of an in-line outdoor optical fiber distribution closure or module 150 according to the invention. Like the modules 10, 12, the module 150 can be mounted to an outside wall or façade of a MDU building, or allowed to hang freely from an aerial network distribution cable outdoors along which the module 150 is installed.

As detailed below, the inventive distribution module 150 can store four SCA connector adapters, and house 36 fusion splices among three splice trays. Each splice tray can be attached pivotally to another tray or to the base of the module. When the module 150 is mounted on a building wall or façade, each tray can be accessed for use right side up by swinging it clear of the module base. When done, the tray is swung back to be stowed upside down inside the module when closed. Each splice tray can retain 12 single fusion splices and a 1×4 splitter in a compact configuration.

The module 150 is versatile and has relatively few loose parts, thereby making it easy for an installer to deploy the module while standing on a ladder outdoors. For example, instead of requiring the installer to use a separate tool to close the module, the installer can close the module and obtain a weather tight seal by operating four levered latches easily by hand.

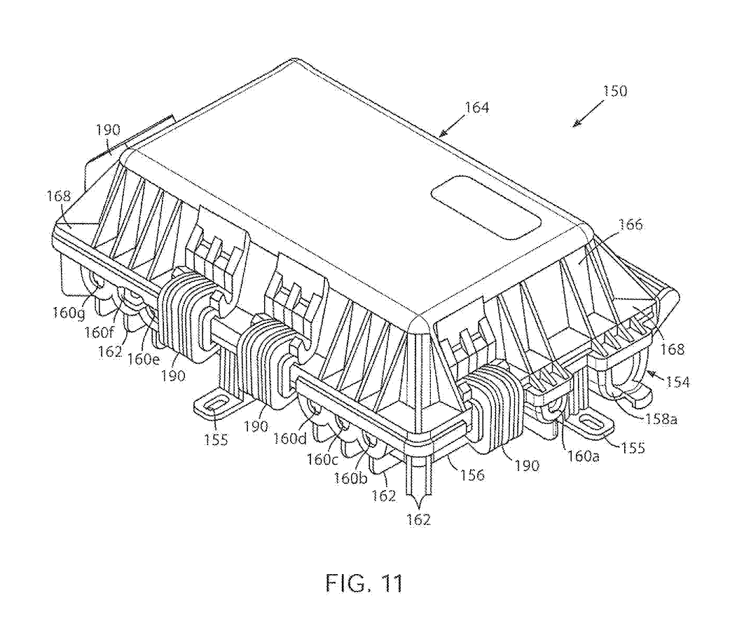

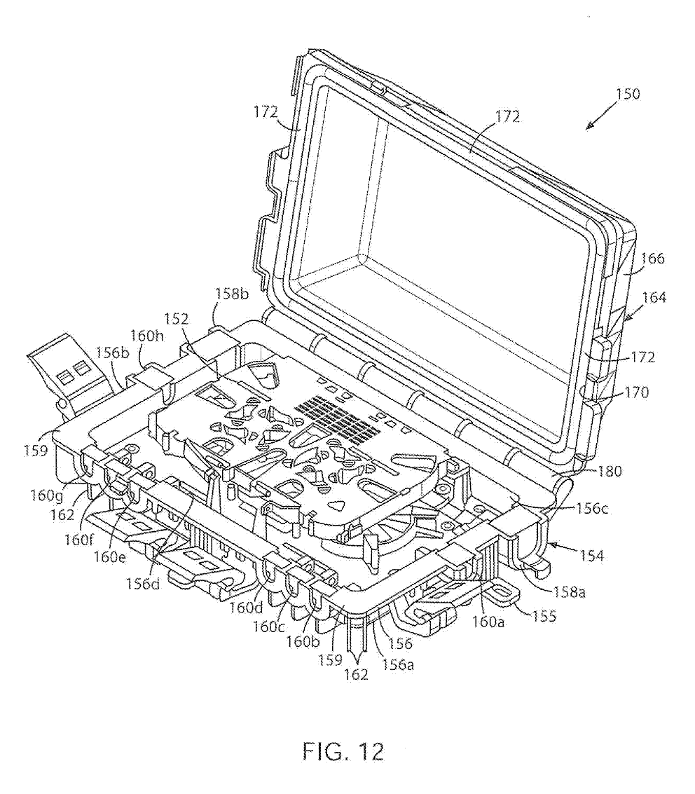

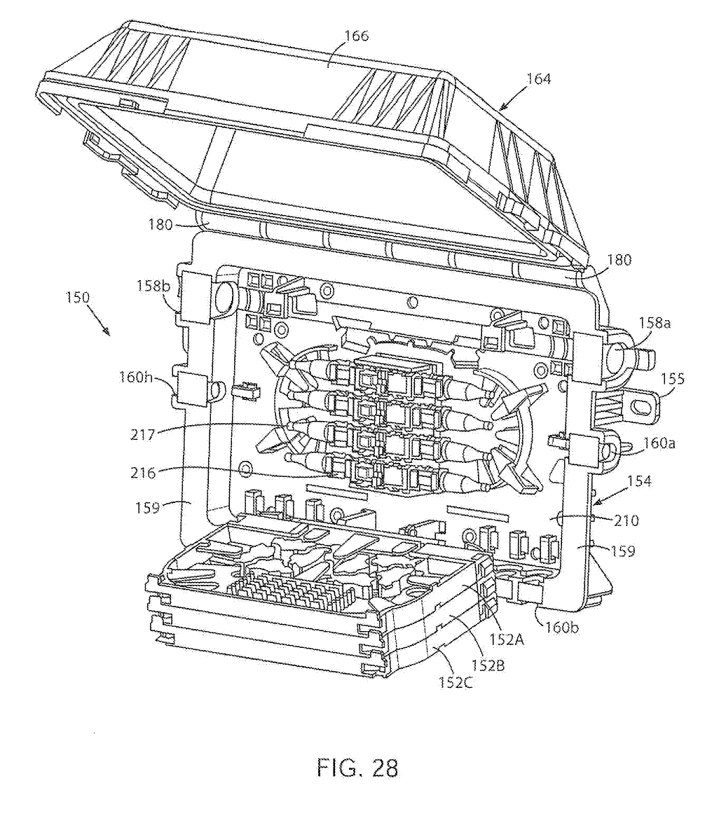

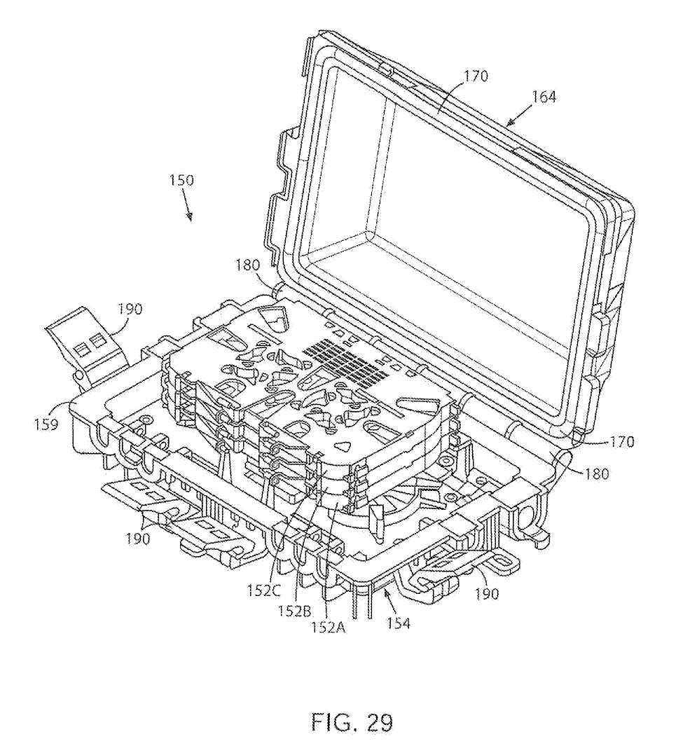

FIG. 11 is a view the inventive optical fiber distribution module 150 when closed, and FIG. 12 shows the module when opened. While FIG. 12 shows only one splice tray 152 mounted for storage inside the module, FIGS. 28 and 29 show the module 150 when accommodating three trays 152.

The distribution module 150 has a generally rectangular base 154 as seen in FIGS. 11 to 13. The base 154 may measure, without limitation, approximately 7.268 inches long (excluding mounting feet 155) and 5.014 inches high, and the base can be fixed to a building façade via screws or other fasteners inserted through the mounting feet 155. Base 154 also has a surrounding wall 156, e.g., 0.928 inch high, and the base can be formed of glass fiber reinforced UV resistant polypropylene or an equivalent RoHS compliant material.

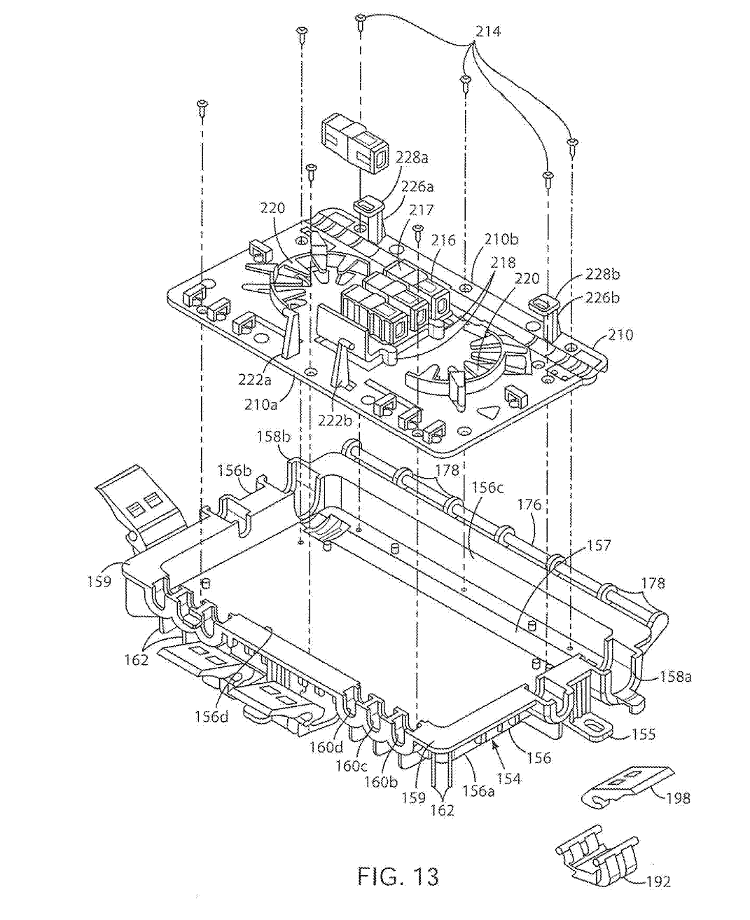

The base wall 156 has a pair of distribution cable ports 158a, 158b formed in opposite short sides 156a, 156b of the wall 156, and near a long side 156c of the wall as seen in FIGS. 12 and 13. The ports 158a, 158b enable a fiber distribution cable to pass through the interior region of the module 150, so that designated cable fibers can be removed from the cable and connected to drop fibers that are routed from inside the module to premises inside a MDU building. The cable ports 158a, 158b are in the form of generally U-shaped notches that extend downward from a protruding flat flange 159 on the base wall 156, and the bottom of each port is rounded. The side walls of each cable port may be slightly inclined away from one another toward the surface of the flange 159 on the base wall, thus forming a tight weatherproof seal when a distribution cable and a grommet through which the cable is passed, are urged toward the bottom of the port.

An elongated recess 157 is formed in the bottom surface of the base 154, over its entire length between the two distribution cable ports 158a, 158b. See FIG. 13. The recess 157 is of sufficient depth and width to seat a distribution cable having a relatively large O.D. (e.g., 12 mm) passing through the interior of the module 150 between the ports 158a, 158b. The recess 157 ensures that the top surface of the cable grommet when inserted inside each port 158a, 158b will not rise above the surface on the base flange 159, and that a tight seal will be obtained when the module is closed. The cable recess 157 also allows the overall height of the module 150 to be reduced.

The base wall 156 also has a total of eight fiber ports 160a-h, two of which (160a and 160h) are also formed in the opposite short sides 156a, 156b of the wall, and near the distribution cable ports 158a, 158b as shown in FIGS. 12 and 13. Three fiber ports 160b, 160c, and 160d are formed next to one another in an opposite long side 156d of the base wall 156, and close to the short side 156a of the wall. The other three fiber ports 160e, 160f, and 160g are formed next to one another in the long side 156d of the base wall 156, close to the short side 156b of the wall.

Like the two distribution cable ports 158a, 158b, the eight fiber ports 160a-h are in the form of generally U-shaped notches that extend downward from the surface of the flange 159 on the base wall 156, with a rounded bottom. The side walls of each fiber port are also slightly inclined away from one another toward the surface of the base flange 159 so as to form a weatherproof seal when a drop fiber and a grommet through which the fiber is passed, are urged toward the bottom of the port.

Accordingly, the fiber ports 160a-h allow drop fibers to pass from the interior of the module base 154 where the fibers are connected with designated fibers of the distribution cable, to corresponding premises inside a MDU building. It will be understood, however, that fewer or more than eight fiber ports may be formed in the base wall 156 depending on, inter alia, a greatest number of drop fibers that are expected to be handled by the distribution module 150.

The base wall 156 also has a number of reinforcing ribs 162 that project outward from the wall beneath or next to the cable and the fiber ports 158a-b, and 160a-h; and beneath the corners of the of the protruding flange 159 on the base wall 156. The ribs 162 act to support the flange 159 so that the surface of the flange remains flat and does not deform when a cover 164 of the module 150 is clamped to the base 154, as detailed below. That is, the ribs 162 act to stiffen the module base 154 at all critical sealing points between the base 154 and the cover 164 of the module 150.

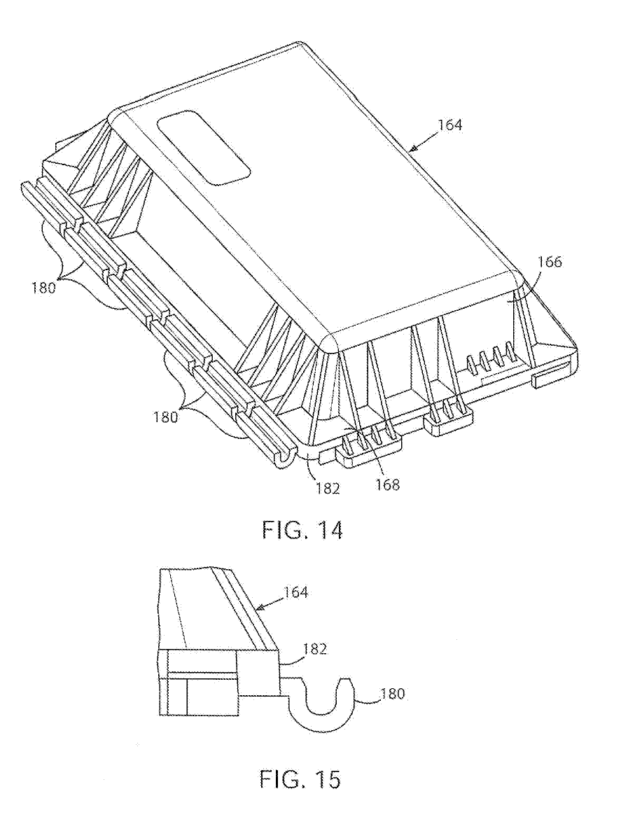

Like the module base 154, the cover 164 (also shown in FIGS. 14, 15, 28, and 29), can be made of a UV resistant and RoHS compliant material such as glass fiber reinforced polypropylene, or equivalent. The cover 164 can measure, without limitation, approximately 7.598 inches in length, 5.014 inches in width, and 1.549 inches in height. A surrounding wall 166 of the cover 164 also has a protruding flat flange 168 over the closing edge of the wall, and a channel 170 is formed to a depth of, e.g., 0.160 inch below the surface of the flange 168.

The bottom of the channel 170 in the cover 164 provides a continuous and smooth sealing surface against which an oil resistant O-ring sealing element 172 is seated in the channel. A portion of the sealing element 172 is allowed to protrude above the channel 170. Thus, when the module 150 is closed by clamping the cover flange 168 to the base flange 159, the protruding portion of the sealing element 172 is urged into the channel 170 by the surface of the base flange 159 and the top surfaces of the grommets inserted in all of the ports of the base. As a result, a continuous compressive force is applied on the sealing element 172 when the module 150 is closed, and the interface between the module cover 164 and base 154, along with the interior region of the module, are sealed from the outdoor environment.

Module 150 is constructed so that the cover 164 is hinged to the base 154 next to the long side 156c of the base wall 156. See FIGS. 12 to 15. An elongated hinge pin 176 is supported by a number of evenly spaced lugs 178 that project outward from the long side 156c of the base wall, so that the hinge pin 176 is parallel to and spaced apart from the base wall. Segments of the hinge pin 176 between the lugs 178 are engaged by corresponding knuckles or hinge elements 180 that are aligned along a top long side 182 of the module cover 164. See FIGS. 12, 14, and 15. The length of the two outer hinge elements 180 on the cover 164 is preferably set to obtain an interference fit between the corresponding lugs 178 on the base wall 156, so that when swung about the hinge pin 176 to a desired open position, the cover will stay at the open position so an installer can use both hands to splice and manage fibers.

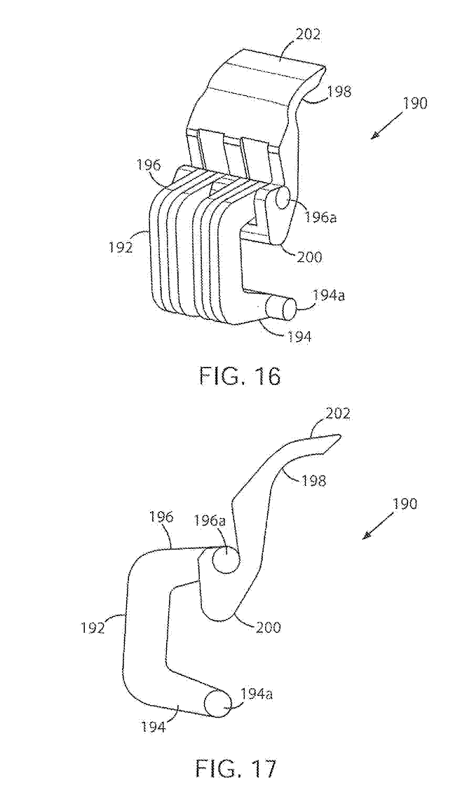

FIGS. 16 and 17 show a two-part latch 190, four of which latches 190 are used to clamp the module cover 164 to the base 154 and thereby seal the interior of the module from the outside environment. See FIG. 11. Each latch 190 includes a catch 192 having a generally U-shaped cross section, a lower arm 194, and an upper arm 196. The latch 190 also includes a lever 198 having a hook portion 200 and an arm 202.

The lower arm 194 of the catch 192 has a horizontal pivot 194a at a distal end of the arm, wherein the pivot 194a is formed to be seated in a corresponding recess formed beneath the flange 159 of the module base 154, at one of four determined locations shown, e.g., in FIG. 11. The upper arm 196 of the catch 192 also has a horizontal pivot 196a that is seated within the lower hook portion 200 of the lever 198.

In use, after the module cover 164 is swung fully downward over the base 154, the arm 202 on the lever 198 of each latch 190 is swung toward the left in FIG. 17 to increase the space between the bottom of the hook portion 200 of the lever 198, and the lower arm 194 of the catch 192. The latch 190 is then placed over the adjoining flanges 159, 168 on the module base and cover at one of the determined locations shown in FIG. 11. The distal end of the lower arm 194 of the catch 192 including the pivot 194a engage the recess beneath the base flange 159, and the arm 202 on the lever 198 is urged toward the right in FIG. 17. As a result, the bottom of the hook portion 200 applies a compressive force on the top of the cover flange 168. The latches 190 are preferably formed and dimensioned so that the force applied by the hook portion 200 of the lever 198 is directed substantially over the center axis of the sealing element 172 inside the cover flange 168.

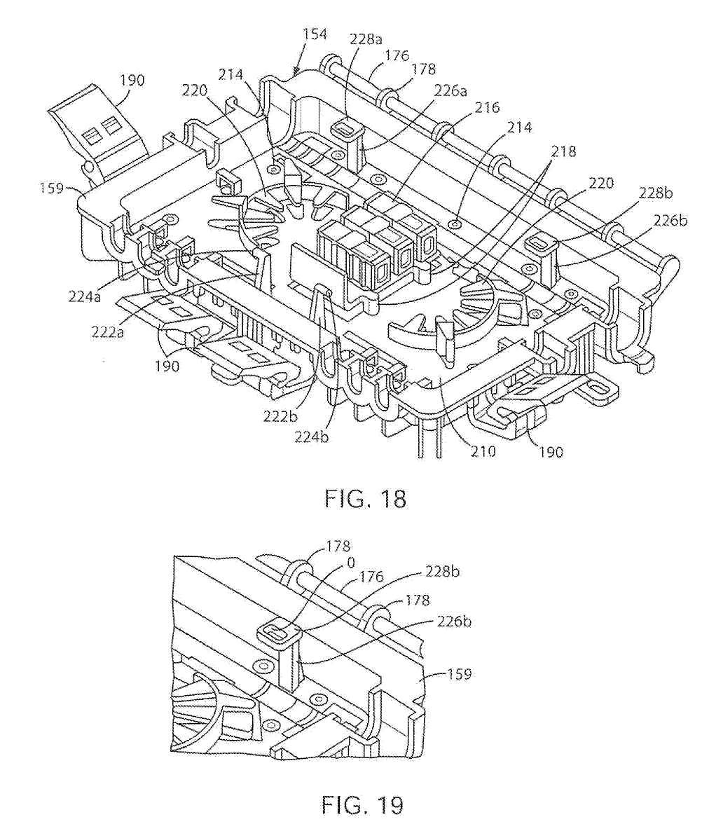

As shown in FIGS. 13 and 18, a base plate 210 is fixed substantially flush with the bottom surface 212 of the module base 154 via, e.g., screws 214 or equivalent fastening means. A bracket 216 for retaining up to, e.g., four connector adapters 217 (e.g., SCA type) is supported over a central region of the base plate 210 by four bosses 218 that rise approximately 0.155 inch from the plate 210. The base plate 210 also has retainers 220 for looping optical fibers over the surface of the plate 210, and allowing enough slack for selected pairs of the fibers to be spliced one another.

Two posts 222a and 222b are fixed to the base plate 210, next to and midway along a bottom edge 210a of the plate 210 (see FIG. 13). The posts are spaced approximately 1.036 inches apart and rise above the plate by about 0.830 inch. Each of the posts 222a, 222b has an associated pivot 224a, 224b that extends from the top of the post, parallel to the bottom edge 210a of the base plate 210, and away from the other post.

Two additional posts 226a, 226b are fixed to the base plate 210, next to a top edge 210b of the plate 210 (see FIG. 13). The posts 226a, 226b are spaced, e.g., about 3.858 inches apart, are each equidistant from the closer side of the base plate 210, and also rise above the plate by about 0.830 inch. Each of the posts 226a, 226b has an associated flat rectangular tab 228a, 228b that extends from the top of the post, parallel to the surface of the base plate 210, and toward the bottom edge 210a of the plate. A rectangular opening O is formed in each tab 228a, 228b as shown in FIG. 19. The two posts 222a, and 222b, and the two additional posts 226a, 226b, serve to engage and manage the splice trays 152 as explained later below.

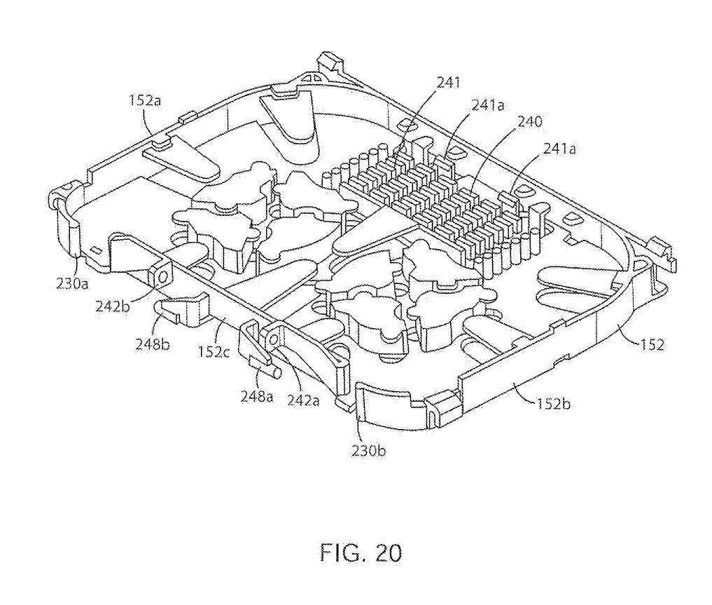

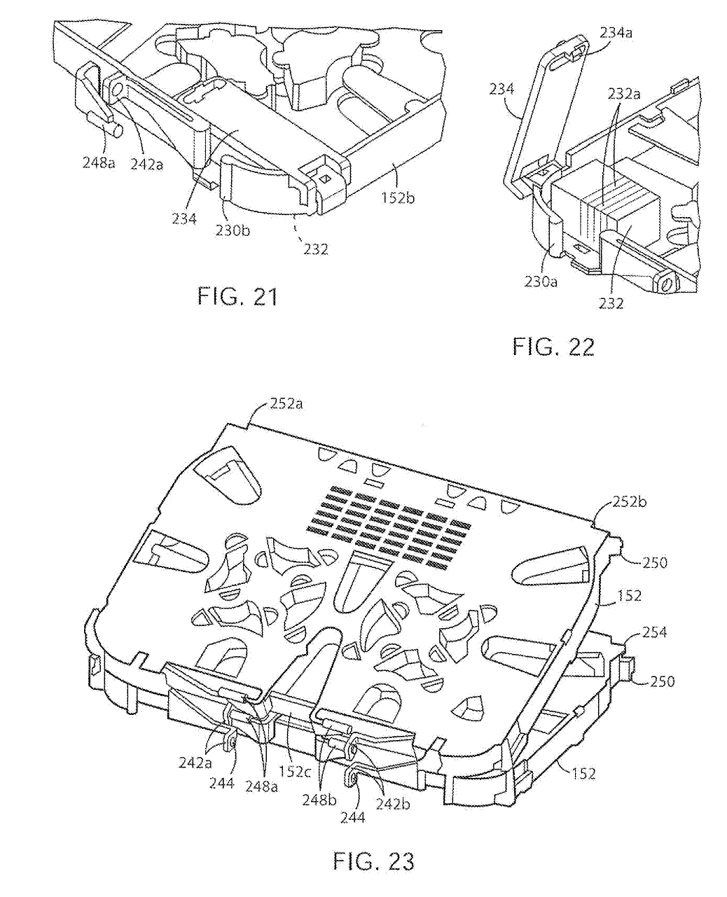

FIGS. 20 to 29 show details of the splice tray 152, including two fiber entrances or ports 230a, 230b on the tray (FIGS. 21 and 22), two of the splice trays 152 pivoted for swinging movement relative to one another (FIGS. 23 to 27), and three of the splice trays 152 pivoted to one another and to the base plate 210 for storage inside the inventive fiber distribution module 150 (FIGS. 28 and 29).

FIG. 20 shows the interior of the splice tray 152. The tray 152 is also provided with a clear, flexible, easily removable cover 153 a portion of which appears in FIG. 27. Tray 152 is generally rectangular and measures, e.g., approximately 4.866 inches long, 3.150 inches wide, and 0.330 inch deep. The tray can be made of polypropylene copolymer or an equivalent material that meets all applicable requirements.

The fiber ports 230a, 230b are formed near opposite ends of a first long side wall 152c of the tray 152. FIGS. 21 and 22 show an arrangement for retaining fibers that enter the ports 230a, 230b inside the tray 152, when the tray is inverted from the position in FIGS. 20 to 22 for storage inside the distribution module 150. See FIGS. 23 to 29 and related text below.

Two foam blocks 232 are fixed on the tray 152, each adjacent to a corresponding one of the fiber ports 230a, 230b. As shown in FIG. 22, a series of slits 232a are cut downward through the block 232 using a blade, wherein the slits 232a are aligned in the direction of the corresponding port. Fibers entering either port 232a or 232b to be spliced, are inserted through the slits in the block 232 adjacent each port. Elongated covers 234 are hinged to corresponding short side walls 152a, 152b of the splice tray 152, and the covers 234 are swung down over the blocks 232 and latched at the free ends 234a of the covers to the tray 152. Accordingly, the covered foam blocks 232 at each fiber port 232a, 232b, and the splice tray covers 153, together serve to keep all fibers that enter the tray ports 232a, 232b inside the tray 152 when the tray is inverted from its position in FIGS. 20 to 22 to be stored inside the module 150.

As seen in FIG. 20, each splice tray 152 has a fusion splice holder section 240 in a region near a second long side wall 152d of the tray. In the disclosed embodiment, the splice holder section 240 includes six parallel rows of retaining fingers 241 or tabs, and a parallel catch wall. The splice holder section 240 is thus capable of retaining up to 12 fusion splices each of which is protected by a splice sleeve, since up to two splice sleeves can be gripped between any two rows of the retaining tabs, and between the catch wall and adjacent tabs. Accordingly, when stored inside the fiber distribution module 150, three of the splice trays 152 together can store up to 36 fusion splices. Provision is also made on each tray 152 to store a 1×4 splitter between a top row of retaining fingers 241 as viewed in FIG. 20, and a pair of tabs 241a facing the top row of retaining fingers 241.

Each splice tray 152 is also capable of attaching pivotally to and latching flush against an adjacent tray 152, or to and against the module base plate 210. FIGS. 23 to 25 show two of the splice trays 152 pivoted to one another for relative swinging movement, and FIGS. 26 & 27 show the two trays latched to one another as a stack, according to the invention. As seen in FIGS. 28 & 29, up to three splice trays 152 can be latched to one another as a stack, and the trays can be swung together and latched to the module base for storage inside the module 150.

Specifically, the long side wall 152c on each splice tray 152 is formed with a pair of flat lugs 242a, 242b that project normal from the wall 152c. Each of the lugs 242a, 242b has an opening 244 sized to receive a corresponding one of the pivots 224a, 224b on the base plate posts 222a, 222b, next to the bottom edge 210a of the base plate 210 inside the module base 154. In the present embodiment, the lugs 242a, 242b are spaced approximately 1.300 inches apart from one another, and the openings 244 are about 0.150 inch from the side wall 152c of the splice tray 152.

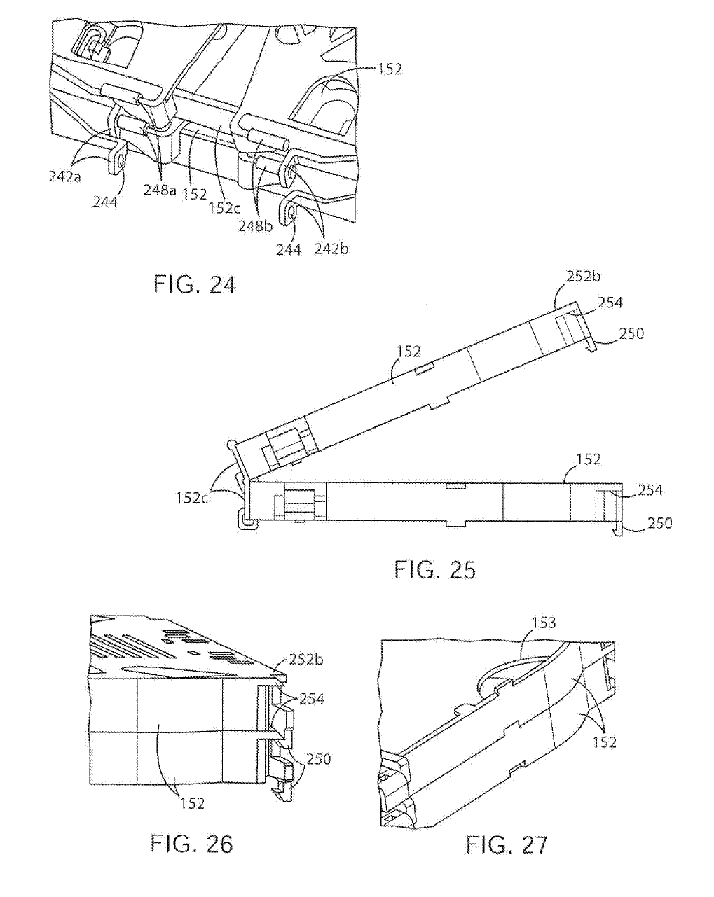

The long side wall 152c of each splice tray 152 is also formed to have a pair of pivots 248a, 248b that extend in opposite directions parallel to the side wall 152c, and approximately 0.150 inch from the wall. The pivots 248a, 248b are aligned above the lugs 242a, 242b on the side wall 152c of the tray as viewed in FIGS. 23 and 24. The free end of each pivot is aligned only minimally beyond the lug beneath it on the side wall 152c. As a result, any two splice trays 152 can be pivoted to one another by receiving the pivots 248a, 248b of the lower tray as viewed in FIGS. 23 to 26, in the openings 244 in the lugs 242a, 242b of the upper tray.

The lower tray 152 in FIGS. 23 to 26 can also be pivoted to the base plate 210 inside the module base 154 by receiving the pivots 224a, 224b on the posts 222a, 222b next to the bottom edge 210a of the plate, in the openings 244 of the lugs 242a, 242b on the lower tray. Moreover, once pivoted to the base plate 210, the lower tray can also be latched to the plate 210 in order to lock the tray from movement relative to the module base 154 as explained below.

Each splice tray 152 has a barbed hook 250 that projects downward beneath the tray from each upper corner 252a, 252b of the tray, as viewed in FIGS. 23, 25, and 26. Each tray 152 also has a lip 254 that protrudes horizontally at each corner 252a, 252b above the hook 250 at the same corner. As a result, after the splice trays 152 in FIGS. 23 to 26 are pivoted to one another and the upper splice tray is swung fully downward as in FIG. 26, the hook 250 at each corner 252a, 252b of the upper tray engages the lip 254 at the same corner of the lower tray. The two trays 152 are then locked flush with one another, and they can be unlocked only by disengaging both of the hooks 250 on the upper tray from the lips 254 on the lower tray.

Once a single splice tray 152 or the lowest tray of a stack of trays is pivoted to the module base plate 210, the tray can also be latched to the base plate 210 as noted above. Specifically, when the tray is swung fully toward the base plate, the hooks 250 at the corners 252a, 252b of the tray are located so that they pass through the openings O in the tabs 228a, 228b atop the posts 226a, 226b, next to the top edge 210b of the base plate 210. (See FIG. 13). Once the tabs 228a, 228b are engaged by the hooks 250, the tray 152 is latched onto the module base plate 210 and can be unlatched only by disengaging both hooks 250 from the post tabs 228a, 228b.

FIG. 28 shows the distribution module 150 with the cover 164 open, with four adapters 217 inserted in the retention bracket 216 on the base plate 210, and with connectors mated to both sides of each adapter. For most installations, the distribution module 150 will need to store only one splice tray 152, viz., the top tray 152A in FIG. 28 which appears as the bottom tray in FIG. 29, as explained below.

Typically, a fiber optic network distribution cable is passed through the module 150, between the distribution cable ports 158a, 158b on the module base 154, and the cable jacket is cut open. A cable fiber designated for servicing given premises inside a MDU building is identified and pulled out of the cable with sufficient slack. The bottom tray 152A in FIG. 29 is unlatched from the module base 154, pivoted outward, and its tray cover 153 is removed to expose the interior of the tray 152A as shown in FIG. 28. The designated cable fiber is then fusion spliced to an unterminated bare fiber that exits from one end of a 1×4 splitter. The splitter also has four fibers that exit from the opposite end of the splitter, and which are terminated in optical connectors (e.g., type SCA). After the designated cable fiber is spliced to the bare splitter fiber, the ends of the spliced fibers are retained together with the 1×4 splitter on the splice tray 152A.

The four connectorized fibers of the splitter are routed out of the splice tray 152A to connect with corresponding sides of the SCA adapters retained on the module base plate 210, and the tray cover 153 is re-applied over the open tray 152A. One to four drop cables are connected via mating connectors to opposite sides of the SCA adapters. After the drop cables are connected, the tray 152A is swung down over the adapters. The drop cables are passed through selected ones of the fiber ports 160a-h on the module base 154, and routed to corresponding premises inside the MDU building. The module cover 164 is latched to the base 154 to establish a weatherproof seal.

If more than four drop cables are required to pass from the module 150 through the ports 160a-h to service corresponding premises inside the MDU building, then any connector initially provided at the end of each additional drop cable is cut off inside the module 150. The bare end of each drop cable fiber is then spliced directly to a designated fiber pulled out of the distribution cable passing through the module, and the ends of the spliced fibers are retained on the tray 152A.

Assume a given distribution cable having 24 fibers enters the cable port 158a of the module 150, a designated fiber is removed and spliced to a 1×4 splitter, and the splice and the splitter are retained on the splice tray 152A. The remaining 23 fibers of the given cable would then typically pass through the interior of the module 150 while contained inside the given cable, and exit the module through the module cable port 158b. If the given cable is not long enough to extend beyond the module 150 so that the cable fibers can be accessed downstream if and when needed, then the remaining 23 fibers of the given cable can be spliced to fibers of a second distribution cable, and the ends of the 23 spliced fibers can be stored in the two additional splice trays 152B, 152C. Trays 152B, 152C are the middle and the bottom tray respectively in FIG. 28, and the middle and the top tray respectively in FIG. 29.

After the tray 152A is closed and latched to the module base 210, the middle tray 152B is pivoted to the tray 152A, the tray 152B is swung clear of the module base 154, and its cover 153 is removed to expose the interior of the tray 152B. Twelve of the remaining 23 fibers of the given cable are spliced to corresponding fibers of the second distribution cable, and the spliced ends of the fibers are retained on the middle tray 152B. The tray 152B is then closed, and swung to latch onto the tray 152A. The third tray 152C is then pivoted to the tray 152B, swung clear of the module base 154, and opened. After the remaining 11 fibers of the given distribution cable are spliced to fibers of the second cable, the fused ends of the fibers are retained on the tray 152C. The tray 152C is then closed, and swung to latch onto tray 152B as shown in FIG. 29. The second distribution cable exits the module 150 through the cable port 158b, and the module cover 164 is clamped to the base 154 to establish a weatherproof seal.

While the foregoing represents preferred embodiments of the present invention, it will be understood by persons skilled in the art that various changes, modifications, and additions can be made without departing from the spirit and scope of the invention within the bounds of the following claims.

We claim:

1. An optical fiber distribution module, comprising:
a base including;
a bottom surface;
a base wall surrounding the bottom surface and having a first flange on a closing edge of the wall;
a pair of cable ports formed in the base wall for passing a network distribution cable through an interior region of the module; and
one or more fiber ports formed in base wall to pass corresponding drop fibers from the interior region of the module where the drop fibers can connect to designated fibers of the distribution cable, to corresponding premises inside a multi-dwelling unit (MDU) building;
a cover including:
a cover wall having a second flange on a closing edge of the cover wall; and
a sealing element associated with the cover for producing a weather tight seal between the base and the cover of the module when the module is closed; and
latches constructed and arranged for clamping the cover of the module to the base for closing the module, wherein each latch includes:
a lever having a lower hook portion and a lever arm; and
a catch having a generally U-shaped cross section, a lower arm, and an upper arm;
wherein a distal end of the lower arm of the catch is configured to engage the first flange on the base wall; and
the upper arm of the catch is formed to be seated within the lower hook portion of the lever; and
wherein the lever and the catch are configured so that when the module cover is closed over the base and (i) the distal end of the lower arm of the catch engages the first flange on the base, and (ii) the lever arm is urged to a closed position, a bottom surface on the lower hook portion of the lever applies a compressive force on the second flange and the sealing element to clamp the module cover to the base with a weather tight seal.

2. An optical fiber distribution module according to claim 1, wherein the bottom surface on the lower hook portion of the lever is formed to direct the compressive force substantially along the axis of the sealing element when the lever arm is at the closed position.

3. An optical fiber distribution module according to claim 1, including a first splice tray constructed and arranged to be pivoted to the base for relative swinging movement.

4. An optical fiber distribution module according to claim 3, wherein the base includes a base plate, first posts fixed to the base plate in the vicinity of a first edge of the plate, and each first post has an associated pivot for engaging the splice tray.

5. An optical fiber distribution module according to claim 4, wherein the splice tray is constructed and arranged to be latched to the base plate

6. An optical fiber distribution module according to claim 5, including second posts fixed to the base plate in the vicinity of a second edge of the plate opposite the first edge, and each second post has an associated tab for engaging the splice tray.

7. An optical fiber distribution module according to claim 3, including a second splice tray substantially identical to the first splice tray, and the first and the second splice trays are constructed and arranged to be pivoted to one another for relative swinging movement.

8. An optical fiber distribution module according to claim 7, wherein the first and the second splice trays are constructed and arranged to be latched to one another.

9. An optical fiber distribution module according to claim 3, wherein the splice tray has two fiber ports, and a retaining device adjacent to each fiber port for retaining fibers that enter the ports inside the tray when the tray is inverted.

10. An optical fiber distribution module according to claim 9, wherein the retaining device includes a foam block.

11. An optical fiber distribution module according to claim 10, wherein the foam block has slits for receiving the fibers entering the associated port, and the retaining device also includes a cover constructed and arranged to be hinged to the splice tray for swinging down on the foam block and for latching to the tray at a free end of the cover.

12. An optical fiber distribution module according to claim 1, wherein the base of the module includes a bracket for retaining a number of connector adapters.

13. An optical fiber distribution module according to claim 1, wherein an elongated recess is formed in the bottom surface of the base between the cable ports in the base wall, for seating a distribution cable passing inside the module between the cable ports.

14. An optical fiber distribution module according to claim 1, wherein the cover of the module is hinged to the base next to a side of the base wall.

15. An optical fiber distribution module according to claim 14, including an elongated hinge pin, and a number of lugs projecting outward from the side of the base wall for supporting the hinge pin parallel to the base wall.

16. An optical fiber distribution module according to claim 15, including a number of hinge elements aligned along a side of the cover for engaging corresponding segments of the hinge pin between the lugs that project outward from the side of the base wall.

17. An optical fiber distribution module according to claim 16, wherein at least one of the hinge elements along the side of the cover is sized to interfere with the corresponding lugs on the side of the base wall, so that the module cover will stay open at a desired position.

18. An optical fiber distribution module according to claim 7, including a third splice tray substantially identical to the first and the second splice trays, and the third splice tray is pivoted to the second splice tray for relative swinging movement.
